(19) United States
(12) Patent Application Publication
(10) Pub. No.: US 2006/0284333 A1
(43) Pub. Date: Dec. 21, 2006

(54) Method for producing pellets of liquid-crystalline polymer or pellets of liquid-crystalline polymer composition

(75) Inventors: Motoki Asahara, Sanda-shi (JP); Hiroyuki Kato, Kawanishi-shi (JP)

Correspondence Address: SUGHRUE MION, PLLC, 2100 PENNSYLVANIA AVENUE, N.W., SUITE 800, WASHINGTON, DC, 20037, US

(73) Assignee: Kabushiki Kaisha Ueno Seiyaku Oyo Kenkyujo

(21) Appl. No.: 11/444,339

(22) Filed: Jun. 1, 2006

(30) Foreign Application Priority Data
Jun. 1, 2005 (JP) 2005-161405

(51) Int. Cl. B29B 9/06

(52) U.S. Cl. 264/140; 264/143

(57) ABSTRACT

The present invention provides a method for producing pellets or pellets of a liquid-crystalline polymer composition with a reduced amount of anionic impurities such as chloride, nitrate and sulfate ions. The present invention provides a method for producing pellets of a liquid-crystalline polymer, which comprises: providing a molten state liquid-crystalline polymer in a polycondensation reaction vessel, pulling out the liquid-crystalline polymer from a valve at the bottom of the reaction vessel through a die to give a strand of the polymer, cooling the strand on a water cooling conveyor positioned below the reaction vessel, and cutting the strand to give the pellets, wherein the cooling water for the strand is pure water whose electrical conductance is not more than 10 μS/cm.

### TECHNICAL FIELD

The present invention relates to a method for producing pellets of highly pure liquid-crystalline polymer or liquid-crystalline polymer composition with a reduced amount of anionic impurities such as chloride, nitrate and sulfate ions.

### BACKGROUND ART

Recently, the art wishes improved materials with advantageous properties such as lightweight property and high molding processability in various fields such as electric, electronic and machine industries. In these fields, inorganic materials such as metals have been replaced with engineering plastics as the development of the engineering plastics with high performances such as heat resistance and mechanical properties. For example, the application of the engineering plastics for magnetic recording media such as a hard disk drive with very thin and small parts is desired.

Among the engineering plastics, thermoplastic liquid-crystalline polymer (which is called as liquid-crystalline polymer or LCP hereinafter) has good properties including heat resistance, mechanical properties such as rigidity, chemical resistance, dimensional accuracy and flowability upon molding, and is used not only for molded articles but also for a variety of products. Particularly, personal computers and mobile phones employ highly integrated devices and the art wishes to use downsized, thinner and smaller parts for them. In the information and telecommunication fields, very thin parts, as thin as 0.5 mm or less of the thickness, are sometimes required. Based on the excellent properties of the LCP, consumption of the LCPs has been increasing.

Liquid-crystalline polymers are generally provided as pellets for various uses. Methods for manufacturing the pellets of liquid-crystalline polymers or liquid-crystalline polymer compositions comprising liquid-crystalline polymers and fillers and/or reinforcements have been already known (See Japanese Patent Application Laid Open Nos. 2001-277238 and 2002-144330).

However, no industry applicable method for manufacturing pellets of liquid-crystalline polymer or liquid-crystalline polymer composition with high purity required for the manufacture of hard disk drives and the like has yet been known.

### SUMMARY OF THE INVENTION

An object of the present invention is to provide pellets of highly pure liquid-crystalline polymer which contain less anionic impurities such as chloride, nitrate, and sulfate ions.

Another object of the present invention is to provide pellets of highly pure liquid-crystalline polymer composition which contain less anionic impurities such as chloride, nitrate, and sulfate ions.

The present invention provides methods for producing pellets of a liquid-crystalline polymer and of a liquid-crystalline polymer composition which are described below (1) to (3):

(1) A method for producing pellets of a liquid-crystalline polymer, which comprises:

providing a molten state liquid-crystalline polymer in a polycondensation reaction vessel,

pulling out the liquid-crystalline polymer from a valve at the bottom of the reaction vessel through a die to give a strand of the polymer,

cooling the strand on a water cooling conveyor positioned below the reaction vessel, and

cutting the strand to give the pellets,

wherein the cooling water for the strand is pure water whose electrical conductance is not more than 10 μS/cm.

(2) A method for producing pellets of a liquid-crystalline polymer composition, which comprises:

pulling out a molten state liquid-crystalline polymer composition which comprises a liquid-crystalline polymer, filler and/or reinforcement from a kneading machine to give a strand of the polymer composition,

cooling the strand with cooling water to solidify the strand, and

cutting the strand to give the pellets,

wherein the cooling water for the strand is pure water whose electrical conductance is not more than 10 μS/cm.

(3) A method for purifying pellets of a crude liquid-crystalline polymer or liquid-crystalline polymer composition, which comprises washing the pellets of the crude liquid-crystalline polymer or liquid-crystalline polymer composition containing more than 0.3 μg/g of chloride, nitrate and sulfate ions in total with pure water whose electrical conductance is not more than 10 μS/cm.

The present invention also provides pellets of a liquid-crystalline polymer or liquid-crystalline polymer composition, which contain not more than 0.3 μg/g of chloride, nitrate and sulfate ions in total.

In the present specification and claims, the content of chloride, nitrate or sulfate ion contained in pellets of a liquid-crystalline polymer or liquid-crystalline polymer composition is determined by the following method.

<Method for Determining the Amount of Each Ion>

To 10 g of pellets of a liquid-crystalline polymer or liquid-crystalline polymer composition, 50 ml of pure water whose electrical conductance is 0.06 μS/cm is added, the mixture is stood for five days and then soaked in an ultrasonic bath for 10 hours. Thereafter, the mixture is stood for another 24 hours and at the end of this time period, the amount of each ion extracted in the water is defined as the content of each ion.

### BRIEF DESCRIPTION OF THE DRAWING

FIG. 1 is a schematic illustration of the reaction vessel used for the method of the present invention.

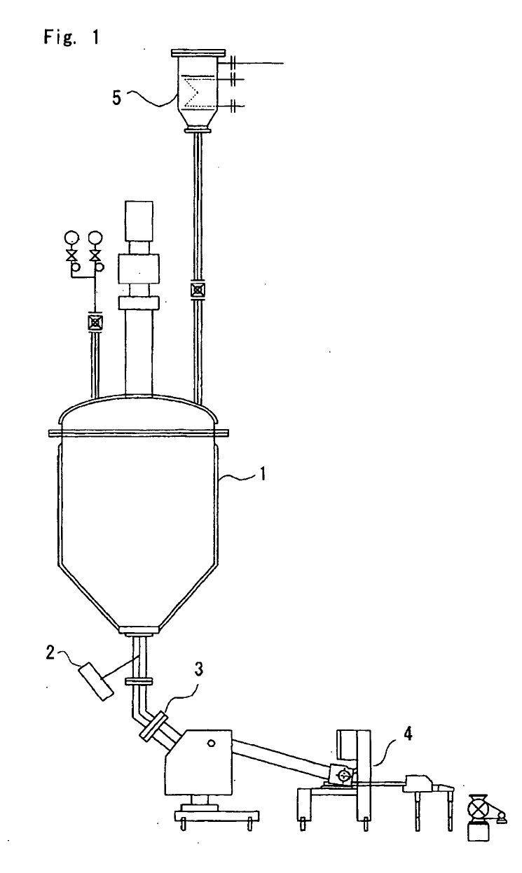

The reaction vessel 1 is equipped with condenser 5. The molten polymer is pulled out from valve 2 at the bottom of the vessel through dice 3 to give strands of the polymer. The strands are cooled on a water cooling conveyor positioned below the reaction vessel and cut into pellets by cutter 4.

### BEST MODE FOR CARRYING OUT THE INVENTION

In the specification and claims of the present application, the term “die” refers to both of a die which has one opening and dice which have more than one openings.

In the specification and claims, the term “liquid-crystalline polymer” refers to a polyester resin or a polyester amide resin which exhibits anisotropic melt phase and is called as thermotropic liquid-crystalline polyester resin or thermotropic liquid-crystalline polyester amide resin by those skilled in the art.

The anisotropic melt phase can be confirmed by means of conventional polarized light system using orthogonal light polarizer. In more detail, the sample on the hot stage under nitrogen atmosphere may be observed.

The liquid-crystalline polymer used in the present invention is that obtained by a conventional polymerization method using a combination of monomers selected from aromatic hydroxycarboxylic acids, aromatic diols, aromatic dicarboxylic acids, aromatic hydroxyamines, aromatic diamines, aromatic aminocarboxylic acids, aliphatic diols, and derivatives thereof.

Examples of aromatic hydroxycarboxylic acids preferably used as monomers for the liquid-crystalline polymer of the present invention include 4-hydroxybenzoic acid, 3-hydroxybenzoic acid, 2-hydroxybenzoic acid, 2-hydroxy-6-naphthoic acid, 2-hydroxy-5-naphthoic acid, 2-hydroxy-3-naphthoic acid, 4′-hydroxyphenyl-4-benzoic acid, 3′-hydroxyphenyl-4-benzoic acid, 4′-hydroxyphenyl-3-benzoic acid and alkyl-, alkoxy-, or halogen-substituted derivatives as well as ester forming derivatives thereof. Among the above, 4-hydroxybenzoic acid and 2-hydroxy-6-naphthoic acid are especially preferable.

Examples of aromatic diols preferably used as monomers for the liquid-crystalline polymer of the present invention include hydroquinone, resorcin, 2,6-dihydroxynaphthalene, 2,7-dihydroxynaphthalene, 1,6-dihydroxynaphthalene, 4,4′-dihydroxybiphenyl, 3,3′-dihydroxybiphenyl, 3,4′-dihydroxybiphenyl, 4,4′-dihydroxybiphenyl ether, bis(4-hydroxyphenyl)ethane and ester forming derivatives thereof. Among them, hydroquinone and 4,4′-dihydroxybiphenyl are especially preferable.

Examples of aromatic dicarboxylic acids preferably used as monomers for the liquid-crystalline polymer of the present invention include, terephthalic acid, isophthalic acid, 2,6-naphthalenedicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenoxy)butane, bis(4-carboxyphenyl)ethane, bis(3-carboxyphenyl)ether, bis(3-carboxyphenyl)ethane and ester forming derivatives thereof. Among them, terephthalic acid and 2,6-naphthalenedicarboxylic acid are especially preferable.

Examples of aromatic hydroxyamines, aromatic diamines, aromatic aminocarboxylic acids and the like preferably used as monomers for the liquid-crystalline polymer of the present invention include aromatic hydroxyamines such as 4-aminophenol, N-methyl-4-aminophenol, 3-aminophenol, 3-methyl-4-aminophenol, 4-amino-1-naphthol, 4-amino-4′-hydroxydiphenyl, 4-amino-4′-hydroxydiphenyl ether, 4-amino-4′-hydroxybiphenylmethane, and 4-amino-4′-hydroxybiphenylsulfide, aromatic diamines such as 4,4′-diaminodiphenylsulfone, 1,4-phenylenediamine, N-methyl-1,4-phenylenediamine, N,N′-dimethyl-1,4-phenylenediamine, 1,3-phenylenediamine, 4,4′-diaminophenylsulfide(thiodianiline), 2,5-diaminotoluene, 4,4′-ethylenedianiline, 4,4′-diaminodiphenoxyethane, 4,4′-diaminobiphenylmethane(methylenedianiline), and 4,4′-diaminodiphenylether(oxydianiline) and aromatic aminocarboxylic acids such as 4-aminobenzoic acid and 3-aminobenzoic acid as well as ester forming derivatives thereof.

Examples of aliphatic diols preferably used as monomers for the liquid-crystalline polymer of the present invention include, linear or branched aliphatic diols such as ethylene glycol, propylene glycol, butylene glycol, 1,3-propanediol, 1,2-propanediol, 1,4-butanediol, 1,6-hexanediol and neopentyl glycol as well as ester forming derivatives thereof.

These monomers may be substituted with C1-C6 alkyl group, C1-C6 alkoxy group or halogen atom.

The liquid-crystalline polymer of the present invention may be those prepared by copolymerizing the above-described monomers with one or more additional monomers such as alicyclic dicarboxylic acids, alicyclic diols, aromatic mercaptocarboxylic acids, aromatic dithiols, and aromatic mercaptophenols unless the additional monomers do not impair the object of the present invention. In other words, the liquid-crystalline polymer of the present invention may be.

Examples of alicyclic dicarboxylic acids and alicyclic diols include hexahydroterephthalic acid, trans-1,4-cyclohexanediol, cis-1,4-cyclohexanediol, trans-1,4-cyclohexanedimethanol, cis-1,4-cyclohexanedimethanol, trans-1,3-cyclohexanediol, cis-1,2-cyclohexanediol and trans-1,3-cyclohexanedimethanol as well as ester forming derivatives thereof.

Examples of aromatic mercaptocarboxylic acids, aromatic dithiols and aromatic mercaptophenols include 4-mercaptobenzoic acid, 2-mercapto-6-naphthoic acid, 2-mercapto-7-naphthoic acid, benzene-1,4-dithiol, benzene-1,3-dithiol, 2,6-naphthalenedithiol, 2,7-naphthalenedithiol, 4-mercaptophenol, 3-mercaptophenol, 6-mercaptophenol and 7-mercaptophenol as well as ester forming derivatives thereof.

The liquid-crystalline polymers composed of the above-described monomers may include both of those give anisotropic melt phase and those do not, depending on the structural components of the polymer, the ratio thereof, and the sequence distribution. The liquid-crystalline polymers used in the present invention are limited to those exhibit anisotropic melt phase.

Preferable liquid-crystalline polymers are those having following monomer constituents: 4-hydroxybenzoic acid/2-hydroxy-6-naphthoic acid copolymer 4-hydroxybenzoic acid/terephthalic acid/4,4′-dihydroxybiphenyl copolymer 4-hydroxybenzoic acid/terephthalic acid/isophthalic acid/4,4′-dihydroxybiphenyl copolymer 4-hydroxybenzoic acid/terephthalic acid/isophthalic acid/4,4′-dihydroxybiphenyl/hydroquinone copolymer 4-hydroxybenzoic acid/terephthalic acid/hydroquinone copolymer 2-hydroxy-6-naphthoic acid/terephthalic acid/hydroquinone copolymer 4-hydroxybenzoic acid/2-hydroxy-6-naphthoic acid/terephthalic acid/4,4′-dihydroxybiphenyl copolymer 2-hydroxy-6-naphthoic acid/terephthalic acid/4,4′-dihydroxybiphenyl copolymer 4-hydroxybenzoic acid/2-hydroxy-6-naphthoic acid/terephthalic acid/hydroquinone copolymer 4-hydroxybenzoic acid/2,6-naphthalenedicarboxylic acid/4,4′-dihydroxybiphenyl copolymer 4-hydroxybenzoic acid/terephthalic acid/2,6-naphthalenedicarboxylic acid/hydroquinone copolymer 4-hydroxybenzoic acid/2,6-naphthalenedicarboxylic acid/hydroquinone copolymer 4-hydroxybenzoic acid/2-hydroxy-6-naphthoic acid/2,6-naphthalenedicarboxylic acid/hydroquinone copolymer 4-hydroxybenzoic acid/terephthalic acid/2,6-naphthalenedicarboxylic acid/hydroquinone/4,4′-dihydroxybiphenyl copolymer 4-hydroxybenzoic acid/terephthalic acid/4-aminophenol copolymer 2-hydroxy-6-naphthoic acid/terephthalic acid/4-aminophenol copolymer 4-hydroxybenzoic acid/2-hydroxy-6-naphthoic acid/terephthalic acid/4-aminophenol copolymer 4-hydroxybenzoic acid/terephthalic acid/4,4′-dihydroxybiphenyl/4-aminophenol copolymer 4-hydroxybenzoic acid/terephthalic acid/ethylene glycol copolymer 4-hydroxybenzoic acid/terephthalic acid/4,4′dihydroxybiphenyl/ethylene glycol copolymer 4-hydroxybenzoic acid/2-hydroxy-6-naphthoic acid/terephthalic acid/ethylene glycol copolymer 4-hydroxybenzoic acid/2-hydroxy-6-naphthoic acid/terephthalic acid/4,4′-dihydroxybiphenyl/ethylene glycol copolymer.

Among the above, the preferable liquid-crystalline polymers of the present invention are those comprising repeating units represented by formulae [I] and [II] and, if desired, optional repeating units represented by formulae [III] and/or [IV]. 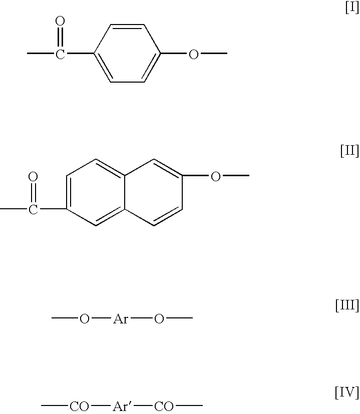
wherein Ar and Ar′ independently represents benzene ring, naphthalene ring, biphenyl ring, biphenyl ether ring or biphenyl C1-C4 alkane ring; and the rings may be substituted with alkyl group, alkoxy group or halogen atom.

Examples of preferable monomers which give repeating units represented by formula [I] include 4-hydroxybenzoic acid and its derivatives. Examples of preferable monomers which give repeating units represented by formula [II] include 2-hydroxy-6-naphthoic acid and its derivatives. Examples of preferable monomers which give repeating units represented by formula [III] include 2,6-naphthalenedicarboxylic acid and terephthalic acid as well as their derivatives. Examples of preferable monomers which give repeating units represented by formula [IV] include hydroquinone and 4,4′-dihydroxybiphenyl as well as their derivatives.

When repeating units represented by formulae [I] and [II] are used, the molar proportion between those repeating units, i.e. [I]/[II], is preferably 10/90-90/10 and is more preferably 20/80-80/20. When repeating units represented by formulae [I], [II], [III] and [IV] are used, the molar proportion of [I]/[II] is preferably that described above and the molar proportion between the total amount of repeating units of formulae [I] and [II] and that of repeating units of formulae [III] and [IV], i.e. ([I]+[II])/([III]+[IV]) is preferably 90/10-50/50 and is more preferably 85/15-60/40.

The method for preparing the liquid-crystalline polymer of the present invention is not limited and any known method can be employed. For example, a conventional polymerization method such as molten acidolysis method may be employed. In the molten acidolysis method, the polymerizing monomers are heated to give a molten solution of the reactants and then the solution is reacted to give the molten polymer.

In the molten acidolysis method, the monomer components used for the preparation of the liquid-crystalline polymer may be in the acylated form which are obtained by acylating the hydroxyl and/or amino groups of the monomers. Among the C₂₋₅ acyl groups, C₂₋₃ acyl groups are preferable. C₂ acylated or acetylated monomers are most preferably used for the reaction.

The C₂₋₅ acylated monomers may be those prepared beforehand by acylating the monomers independently or may be those produced in the reaction system by adding an acylating agent such as acetic anhydride to the monomers upon preparing the liquid-crystalline polymer.

In the polymerization method, a catalyst may be used in the reaction, if desired.

Examples of the catalysts include organic tin compounds such as dialkyl tin oxide (ex. dibutyl tin oxide) and diaryl tin oxide; antimony trioxide; alkaline or alkaline earth metal salt of carboxylic acid such as potassium acetate; and gaseous acid catalysts such as Lewis acid (ex. BF₃) and halogenated hydrogen (ex. HCl).

When a catalyst is used, the amount of the catalyst added to the reaction based on the total monomers may preferably be 10-1000 ppm, and more preferably be 20-200 ppm.

The final step of the polymerization method may be carried out under vacuum to facilitate the removal of the volatile by-products such as carboxylic acids or water.

Thus obtained liquid-crystalline polymer in molten state is pulled out of the polycondensation reaction vessel from a valve at the bottom of the reaction vessel through dice to give strands of the polymer. The strands are cooled on a water cooling conveyor positioned below the reaction vessel, and are cut to give the pellets.

In the present invention, the cooling water for the strands of the liquid-crystalline polymer is pure water whose electrical conductance is not more than 10 μS/cm and preferably is not more than 5 μS/cm.

The pure water whose electrical conductance is not more than 10 μS/cm may be obtained by any conventional water purification method. For example, purification methods such as ion exchange, distillation, reverse osmosis membrane (RO membrane) method and combinations thereof may be employed.

The flow amount of the cooling water is preferably 1-20 parts by weight and is more preferably 5-15 parts by weight per one part by weight of the liquid-crystalline polymer pulled out from the reaction vessel.

When the cooling water flow is less than one part by weight, the cooling effect may be insufficient and may cause fusion of the pellets. On the other hand, when the cooling water flow is more than 20 parts by weight, water current may be too strong to carry the strands steadily and may cause splash of the cooling water.

When the electrical conductance of the water after used for cooling the strands is not more than 10 μS/cm, it may be directly recycled without any purification. On the contrary, the electrical conductance of the water once used for cooling the strands is more than 10 μS/cm, it may be recycled after purified by methods such as ion exchange, distillation and reverse osmosis membrane (RO membrane) method.

The shape of the pellets provided by the method of the present invention may preferably be columnar in view of easy handling upon packaging and processing. The columnar pellet may preferably have a diameter of 2.5-4.0 mm and a height of 2.5-5.0 mm.

The water attached to the resulting pellets is removed thoroughly, and the pellets are dried and then subjected to molding into various molded articles.

The pellets of the liquid-crystalline polymer obtained by the method of the present invention contain not more than 0.3 μg/g and preferably not more than 0.2 μg/g of chloride, nitrate and sulfate ions in total.

The pellets of the liquid-crystalline polymer obtained by the method of the present invention contain not more than 0.1 μg/g and preferably not more than 0.05 μg/g of each of chloride, nitrate and sulfate ions.

In the present invention, anion contents in the pellets of the liquid-crystalline polymer are determined by the following procedure.

<Extraction of Anionic Impurities>

To 10 g of pellets of a liquid-crystalline polymer or liquid-crystalline polymer composition, 50 ml of pure water whose electrical conductance is 0.06 μS/cm is added, the mixture is stood for five days and soaked in ultrasonic bath for ten hours. Thereafter, the mixture is stood for another 24 hours.

<Determination of the Extracted Anionic Impurities>

Reference solutions of each of chloride, nitrate and sulfate ions are diluted with the pure water whose electrical conductance is 0.06 μS/cm to give the diluted reference solutions of each of ions. These diluted reference solutions are subjected to ion chromatography. Standard curves of these ions are created from the determined ion concentrations and peak areas.

The extracts of anionic impurity to be determined are filtrated by particle removal filters and then subjected to ion chromatography. The ion concentrations are obtained by the resultant peak areas and the standard curves of the each of the ions.

Blank experimentation is carried out by conducting the above-described extraction step without using any pellets.

The present invention further provides a method for producing pellets of a liquid-crystalline polymer composition comprising the above-described liquid-crystalline polymer. The pellets of the liquid-crystalline polymer composition may be those obtained by admixing one or more fibrous, plate or particulate filler and/or reinforcement to the liquid-crystalline polymer.

Examples of fibrous fillers and/or reinforcements may include glass fiber, silica-alumina fiber, alumina fiber, carbon fiber and aramid fiber. Among them, glass fiber is preferably used.

Examples of plate or particulate fillers and/or reinforcements may include talc, mica, graphite, wollastonite, calcium carbonate, dolomite, clay, glass flake, glass beads and titanium oxide.

The fillers and/or reinforcements may be added to the liquid-crystalline polymer composition in an amount of preferably not more than 100 parts by weight, more preferably 20-70 parts by weight to 100 parts by weight of the liquid-crystalline polymer.

If the amount of fillers and/or reinforcements is more than 100 parts by weight, the moldability of the resulting liquid-crystalline polymer composition tends to be decreased or the exhausting of the cylinder or die of the molding device tends to be increased.

The liquid-crystalline polymer composition of the present invention may comprise one or more additional resin component unless the additional resin component does not impair the object of the present invention. Examples of the additional resin components include thermoplastic resins such as polyamide, polyester, polyphenylene sulfide, polyether ketone, polycarbonate, polyphenylene ether and denatured derivatives thereof, polysulfone, polyethersulfone and polyether imide and thermosetting resins such as phenol resin, epoxy resin and polyimide resin.

The liquid-crystalline polymer composition of the present invention may be obtained by adding fillers, reinforcements and other resin components to the liquid-crystalline polymer and melt kneading the mixture at a temperature from near the melting point of the polymer to the melting point plus 100° C. using a kneading machine such as kneader, single screw extruder, twin screw extruder or the like.

The resulting liquid-crystalline polymer composition admixed with fillers, reinforcements and optionally other resin components is pulled out from the kneading machine to give strands, which are solidified by cooling with cooling water and then are cut to give the pellets of the liquid-crystalline polymer composition.

In the present invention, the cooling water for the strands of the liquid-crystalline polymer composition is pure water whose electrical conductance is not more than 10 μS/cm and is preferably not more than 5 μS/cm.

The flow amount of the cooling water is preferably 0.01-2 parts by weight and is more preferably 0.03-1 parts by weight per one part by weight of the liquid-crystalline polymer composition pulled out from the kneading machine.

When the cooling water flow is less than 0.01 parts by weight, the cooling effect may be insufficient and may cause fusion of the pellets.

When the electrical conductance of the water after used for cooling the strands is not more than 10 μS/cm, it may be directly recycled without any purification. On the contrary, the electrical conductance of the water once used for cooling the strands is more than 10 μS/cm, it may be recycled after purified by methods such as ion exchange, distillation and reverse osmosis membrane (RO membrane) method.

The shape of the pellets provided by the method of the present invention may preferably be columnar in view of easy handling upon packaging and processing. The columnar pellet may preferably have a diameter of 2.5-4.0 mm and a height of 2.5-5.0 mm.

The water attached to the resulting pellets is removed thoroughly, and the pellets are dried and then subjected to molding into various molded articles.

The pellets of the liquid-crystalline polymer composition obtained by the method of the present invention contain not more than 0.3 μg/g and preferably not more than 0.2 μg/g of chloride, nitrate and sulfate ions in total.

The pellets of the liquid-crystalline polymer composition obtained by the method of the present invention contain not more than 0.1 μg/g and preferably not more than 0.05 μg/g of each of chloride, nitrate and sulfate ions.

The present invention also provides a method for purifying pellets of a crude liquid-crystalline polymer or liquid-crystalline polymer composition, which comprises washing pellets of the crude liquid-crystalline polymer or liquid-crystalline polymer composition containing more than 0.3 μg/g of chloride, nitrate and sulfate ions in total with pure water whose electrical conductance is not more than 10 μS/cm.

In the present invention, the cooling water for the pellets of the crude liquid-crystalline polymer or liquid-crystalline polymer composition is pure water whose electrical conductance is not more than 7 μS/cm and is preferably not more than 5 μS/cm. The electrical conductance may be determined depending on the amount of the contaminants in the pellets of the crude liquid-crystalline polymer or liquid-crystalline polymer composition as well as on the costs for purifying water.

The washing the pellets of the crude liquid-crystalline polymer or liquid-crystalline polymer composition may be carried out by any means such as immersing the pellets in the pure water having a desired electrical conductance and then leaving shaking or stirring the same; putting the pellets under running pure water; spraying the pure water onto the pellets and the like.

The amount of the pure water is preferably not less than 3 parts by weight and is more preferably 3-15 parts by weight per one part by weight of the pellets.

Temperature of the pure water is not limited within the range of 1-100° C. and may preferably be 10-60° C.

When the electrical conductance of the water used for washing the pellets is not more than 10 μS/cm, it may be directly recycled without any purification. When the electrical conductance of the water once used for washing the pellets is more than 10 μS/cm, it may be recycled after purified by methods such as ion exchange, distillation and reverse osmosis membrane (RO membrane) method.

The water attached to thus washed pellets is removed thoroughly, and the pellets are dried and then subjected to molding into various molded articles.

The pellets of the liquid-crystalline polymer or liquid-crystalline polymer composition obtained by the method of the present invention contain not more than 0.3 μg/g and preferably not more than 0.2 μg/g of chloride, nitrate and sulfate ions in total.

The pellets of the liquid-crystalline polymer or liquid-crystalline polymer composition washed by the method of the present invention contain not more than 0.1 μg/g and preferably not more than 0.05 μg/g of each of chloride, nitrate and sulfate ions.

The pellets of the liquid-crystalline polymer or liquid-crystalline polymer composition according to the present invention may be molded by using a conventional melt molding process, preferably injection molding, compression molding, extrusion molding and blow molding to provide parts of electric and electronic devices, machines and automobiles. The pellets of the liquid-crystalline polymer or liquid-crystalline polymer composition of the present invention are highly pure containing little anionic impurities and therefore, they may be preferably used for manufacturing parts of hard disk drives and the like.

### EXAMPLES

The present invention is further described in reference to the following examples. The following examples are intended to illustrate the invention and are not to be construed to limit the scope of the invention.

In the examples, following abbreviations are used.

POB: 4-hydroxybenzoic acid

BON6: 2-hydroxy-6-naphthoic acid

In the examples, the extraction of anionic impurities and the determination of each ion content were carried out as described above.

### Example 1

255.1 kg (1847 moles) of POB, 128.6 kg (683 moles) of BON6 and 256.6 kg (2581 moles) of acetic anhydride were fed in 1.0 m³ reaction vessel made of SUS equipped with an agitating device and a condenser. Under the nitrogen atmosphere, the mixture was heated from the room temperature to 145° C. over one hour and kept at 145° C. for one hour. Then the mixture was heated to 325° C. over 8 hours with distilling out the by-product, acetic acid. The polymerization reaction was carried out at 325° C. for 0.30 minutes. Then the pressure was reduced from atmospheric pressure to 50 Torr and when the torque became the predetermined level, nitrogen gas was induced to the vessel until the pressure in the reaction vessel was increased to 0.3 MPa to complete the reaction.

Then, the valve at the bottom of the reaction vessel was opened. The content of the reaction vessel was pulled out through the dice to give strands over 40 minutes. The strands were transferred to the cutter through the water cooling conveyor mounted just under the reaction vessel. Then the strands were cut into pellets by the cutter. The electrical conductance of the cooling water used in this example was 2 μS/cm, the weight of the obtained pellets was 338 kg and the water consumption was 2096 kg.

The contents of chloride, nitrate and sulfate ions in the pellets were 0.05 μg/g, 0.08 μg/g and 0.04 μg/g, respectively.

### Comparative Example 1

The pellets of a liquid-crystalline polymer were obtained by the same method as that of Example 1 except that the electrical conductance of the cooling water used was 162 μS/cm.

The contents of chloride, nitrate and sulfate ions in the pellets were 0.9 μg/g, 0.2 μg/g and 0.5 μg/g, respectively.

### Example 2

174.7 kg (1265 moles) of POB, 81.0 kg (430 moles) of BON6 and 267.0 kg (2593 moles) of acetic anhydride were fed in 1.0 m³ reaction vessel made of SUS equipped with an agitating device and a condenser. Under the nitrogen atmosphere, the mixture was heated from the room temperature to 145° C. over one hour and kept at 145° C. for 0.5 hours. Then the mixture was heated to 350° C. over 8 hours with distilling out the by-product, acetic acid. The polymerization reaction was carried out at 350° C. for 60 minutes. Then the pressure was reduced from atmospheric pressure to 10 Torr and when the torque became the predetermined level, nitrogen gas was induced to the vessel until the pressure in the reaction vessel was increased to 0.3 MPa to complete the reaction.

Then, the valve at the bottom of the reaction vessel was opened. The content of the reaction vessel was pulled out through dice to give strands over 40 minutes. The strands were transferred to the cutter through the water cooling conveyor mounted just under the reaction vessel. Then the strands were cut into pellets by the cutter. The electrical conductance of the cooling water used in this example was 3 μS/cm, the weight of the obtained pellets was 325 kg and the water consumption was 2178 kg.

The contents of chloride, nitrate and sulfate ions in the pellets were 0.03 μg/g, 0.09 μg/g and 0.05 μg/g, respectively.

### Comparative Example 2

The pellets of a liquid-crystalline polymer were obtained by the sate method as that of Example 2 except that the electrical conductance of the cooling water used was 162 μS/cm.

The contents of chloride, nitrate and sulfate ions in the pellets were 0.8 μg/g, 0.3 μg/g and 0.7 μg/g, respectively.

### Example 3

100 Parts by weight of the pellets of the liquid-crystalline polymer obtained in Example 1 and 30 parts by weight of glass fiber (T-474 GH, Nippon Electric Glass Co. Ltd., Shiga, Japan) were melt kneaded using twin screw extruder (twin screw extruder PCM-30 IKEGAI Ltd., Ibaragi, Japan) and the molten phase polymer composition was pulled out from the extruder thorough dice to give strands. The strands were transferred to the cutter through the water cooling conveyor equipped just under the extruder. Then the strands were cut into pellets by a cutter. The electrical conductance of the cooling water used in this example was 2 μS/cm.

The strand frow was 40 kg/hr and the cooling water flow was 2 kg/hr.

The contents of chloride, nitrate and sulfate ions in the pellets were 0.02 μg/g, 0.04 μg/g and 0.03 μg/g, respectively.

### Example 4

100 g of pure water whose electrical conductance was 0.06 μS/cm was added to 50 g of the pellets of the liquid-crystalline polymer obtained in Comparative Example 1 in Erlenmeyer flask and the mixture was shaken gently for 30 seconds and then the pure water was discarded. This procedure was repeated for three times and the resulting pellets of the liquid-crystalline polymer were put on a strainer. 100 g of pure water whose electrical conductance was 0.06 μS/cm was poured gently to pellets on the strainer to wash the pellets.

After drying the pellets thoroughly, contents of chloride, nitrate and sulfate ions in the pellets were 0.06 μg/g, 0.07 μg/g and 0.03 μg/g, respectively.

What is claimed is:

1. A method for producing pellets of a liquid-crystalline polymer, which comprises:
providing a molten state liquid-crystalline polymer in a polycondensation reaction vessel,
pulling out the liquid-crystalline polymer from a valve at the bottom of the reaction vessel through a die to give a strand of the polymer,
cooling the strand on a water cooling conveyor positioned below the reaction vessel, and
cutting the strand to give the pellets,
wherein the cooling water for the strand is pure water whose electrical conductance is not more than 10 μS/cm.

2. The method according to claim 1, wherein the flow amount of the cooling water is 1-20 parts by weight per one part by weight of the liquid-crystalline polymer pulled out from the reaction vessel.

3. The method according to claim 1, wherein the pellet of the liquid-crystalline polymer or liquid-crystalline polymer composition is a columnar pellet with a diameter of 2.5-4.0 mm and a height of 2.5-5.0 mm.

4. A method for producing pellets of a liquid-crystalline polymer composition, which comprises:
pulling out a molten state liquid-crystalline polymer composition which comprises a liquid-crystalline polymer, filler and/or reinforcement from a kneading machine to give a strand of the polymer composition,
cooling the strand with cooling water to solidify the strand, and
cutting the strand to give the pellets,
wherein the cooling water for the strand is pure water whose electrical conductance is not more than 10 μS/cm.

5. The method according to claim 4, wherein flow amount of the cooling water is 0.01-2 parts by weight per one part by weight of the liquid-crystalline polymer composition pulled out from the kneading machine.

6. The method according to any one of claim 4, wherein the pellet of the liquid-crystalline polymer or liquid-crystalline polymer composition is a columnar pellet with a diameter of 2.5-4.0 mm and a height of 2.5-5.0 mm.

7. A method for purifying pellets of a crude liquid-crystalline polymer or liquid-crystalline polymer composition, which comprises washing the pellets of the crude liquid-crystalline polymer or liquid-crystalline polymer composition containing more than 0.3 μg/g of chloride, nitrate and sulfate ions in total with pure water whose electrical conductance is not more than 10 μS/cm.

8. The method according to claim 7, wherein the pure water used for washing the pellets is 3-15 parts by weight per one part by weight of the pellets of the crude liquid-crystalline polymer or liquid-crystalline polymer composition.

9. The method according to any one of claim 7, wherein the pellet of the liquid-crystalline polymer or liquid-crystalline polymer composition is a columnar pellet with a diameter of 2.5-4.0 mm and a height of 2.5-5.0 mm.

10. Pellets of a liquid-crystalline polymer or liquid-crystalline polymer composition, which contains not more than 0.3 μg/g of chloride, nitrate and sulfate ions in total.

11. The pellets of the liquid-crystalline polymer or liquid-crystalline polymer composition according to claim 10, which contains not more than 0.1 μg/g of each of chloride, nitrate and sulfate ions.
